(19) United States
(12) Patent Application Publication
(10) Pub. No.: US 2018/0141287 A1
(43) Pub. Date: May 24, 2018

(54) METHOD OF MANUFACTURING A COMPOSITE COMPONENT

(71) Applicant: ROLLS-ROYCE plc, London (GB)

(72) Inventors: James K LANDER, Bristol (GB); James BOWYER, Derby (GB)

(73) Assignee: ROLLS-ROYCE plc, London (GB)

(21) Appl. No.: 15/574,256

(22) PCT Filed: Jun. 1, 2016
(86) PCT No.: PCT/EP2016/062396

§ 371 Date: Nov. 15, 2017

(30) Foreign Application Priority Data
Jun. 12, 2015 (GB) 1510246.0

(51) Int. Cl. B29C 70/02; B29C 70/82

(52) U.S. Cl. CPC B29C 70/023; B29L 2031/08; B29C 70/82

(57) ABSTRACT

A method of manufacturing a composite component including reinforcing a composite structure by providing a composite structure with a plurality of holes provided therein, and positioning a reinforcement rod in each of the holes. The reinforcement rods are dimensioned to protrude from the holes. The reinforcement rods are cropped to a desired length after the rods have been positioned in the holes.

### TECHNICAL FIELD

The present disclosure concerns a method of reinforcing a composite structure, a method of manufacturing a composite component, and/or a rig for reinforcing a composite structure.

### BACKGROUND

Gas turbine engines are typically employed to power aircraft. Typically a gas turbine engine will comprise an axial fan driven by an engine core. The engine core is generally made up of one or more turbines which drive respective compressors via coaxial shafts. The fan is usually driven via one of the turbines.

The fan may comprise an array of radially extending fan blades mounted on a rotor. The fan blades may be manufactured from metallic or composite materials. Generally composite fan blades include a body formed from plurality of laminated plies that include fibres within a resin matrix.

During operation of the gas turbine engine, the fan blades may be impacted by a foreign object (such as a bird) or if a failure occurs the fan blade may be impacted by another fan blade that has been released from the remainder of the fan. In such impact events the integrity of the fan blade should be maintained. A failure mechanism of concern for composite fan blades is delamination.

To resist delamination the fan blade may be reinforced. One method of reinforcing a composite component such as a fan blade is to use through thickness reinforcement rods or pins.

U.S. Pat. No. 8,893,367, which is incorporated herein by reference, discloses a method by which reinforcement rods can be positioned in a composite component. In the method described in U.S. Pat. No. 8,893,367, a composite material is heated and holes are formed in the material, reinforcement elements are then provided in each of the holes.

### SUMMARY OF DISCLOSURE

The present disclosure is concerned with further developing and enhancing the method described in U.S. Pat. No. 8,893,367.

According to a first aspect there is provided a method of reinforcing a composite structure (e.g. a composite laminated structure). The method comprises providing a composite structure with one or more holes provided therein. A reinforcement rod is positioned in a hole of the composite structure. The reinforcement rod is dimensioned to protrude from the hole. The reinforcement rod is cropped to a desired length.

The cropped reinforcement rod may be pushed down into the hole to a desired position. For example, the cropped rod may be pushed down into the hole such that the cropped reinforcement rod is flush with an outer surface of the composite structure. Alternatively, the rod may be pushed down into the hole to an extent that a desired length of the rod protrudes from the surface so as to create a composite component having a textured surface.

The rod may be cropped at a position spaced from a surface of the composite structure. In this way, the risk of damage to the surface of the component can be mitigated.

The reinforcement rod may be provided at a length such that the reinforcement rod can be cropped multiple times to provide a cropped reinforcement rod (or pin) to multiple holes. Use of such a method can contribute to adapting the method of the first aspect for mass production.

The method may comprise providing a guide that guides the reinforcement rod into the hole.

The reinforcement rod may be cropped at a position adjacent to the guide. For example, the rod may be cropped at a position nearer to the guide than to the composite structure. Provision of a guide can improve support for the rod during the cropping process so as to reduce the risk of damage to the rod. For example, the hole in the composite structure supports one end of the rod and the guide supports an opposite end of the rod.

The guide may be a tube dimensioned to support the rod and permit the rod to slide relative to the guide. For example, the inner diameter of the tube may be a close fit to the diameter of the reinforcement rod. Alternatively, the guide may be provided by one or more jets of water or air.

The reinforcement rod may be cropped to the desired length by shearing the rod.

The reinforcement rod may be sheared using a plate having a tapered portion that impacts the rod to initiate shear. For example the plate may have a wedge-shaped portion. The plate may have a portion having an angled face. The angled face may be angled to the principal plane of the plate by an angle less than 90° and greater than 0°, for example 30 to 60°. The tapered portion and/or angled face may be arranged such that the plate has a longer length at a position near the guide than at a position away from the guide.

The method may comprise providing a composite structure (e.g. a composite laminated structure) having a plurality of holes and positioning a rod in each of the holes. The method may further comprise cropping each of the rods.

A plurality of croppers may be provided and each rod of a plurality (or array) of rods may be cropped by a different cropper. Providing a plurality of croppers can increase the life of the cropper. Furthermore, the provision of a plurality of croppers can reduce the risk of a cropped rod being damaged by limiting contact of the cropped rod with the cropper.

A plate may define the plurality of croppers. For example, the plate may be provided with a plurality of countersunk holes operable to crop a rod.

A reinforcement rod may be received by each hole, or alternatively one or more holes may not receive a reinforcement rod so as to achieve a desired array pattern of rods in the composite component.

The reinforcement rod may be pushed into the hole using a pushing foot.

The method may further comprise heating a composite structure to a predetermined temperature and forming one or more holes in the composite structure.

The composite structure may be heated to a pre-determined temperature over and/or for a pre-determined time period, the pre-determined temperature and time period being selected such that the gel point of the composite structure is not reached. The composite structure may be heated to a temperature greater than room temperature. The temperature may be selected so as to ease formation of holes in the composite structure.

The one or more holes may be formed by inserting a needle or piercing member into the composite structure. The needle may have a conical shaped tip. The needle may be rotated during insertion into the composite structure.

The composite structure may be a polymeric matrix material. The composite structure may comprise a fibre reinforced resin matrix.

The rod may be made from any suitable reinforcement material, for example carbon, glass, metallic materials, ceramic materials, plastic materials or a composite arrangement of such materials.

The reinforcement rod may be provided from lengths of rod fed directly into the guide. The reinforcement rod may be supplied to the guide from a rod supply system that may feed rod from a reel to the guide.

The composite structure once reinforced may define a/or part of a composite component of a gas turbine engine. For example, the composite component may be a fan blade or an engine casing (e.g. a fan casing).

The reinforcement rod (or rods) may be cropped to a desired length after the rods have been positioned in the holes.

According to a second aspect there is provided a method of manufacturing a composite component comprising laying a plurality of plies to form a laminated structure and reinforcing the laminated structure using the method according to the first aspect.

The composite component may be a fan blade for a gas turbine engine.

According to a third aspect there is provided a rig for positioning a reinforcing rod in a composite structure. The rig comprises a cropper for cropping a rod to a desired length at a distance spaced from the surface of the composite structure. A pusher foot is provided for pushing a rod into a hole in the composite structure.

The rig may be operable and arranged to perform the method of the first aspect.

The rig may comprise a guide for guiding a rod into a hole provided in the composite structure. The guide may include a tube for receiving a rod.

The cropper may include a plate having a tapered portion arranged to impact a rod.

The cropper may be configured to slide relative to the guide and adjacent to said guide. For example, the cropper may slide in a direction substantially parallel to the surface of the composite structure. The cropper may be considered to slide in a direction angled (e.g. perpendicular) to a principal axis of the guide, e.g. when the guide is a tube, perpendicular to the longitudinal axis of the tube.

The rig may comprise a plurality of guides for guiding a plurality of rods into a plurality of holes in a composite structure.

The rig may comprise a plurality of croppers. Each cropper may be arranged to crop a different rod.

The cropper may include a plate having a plurality of holes for receiving a plurality of rods. Each hole may be countersunk to provide a tapered portion operable to shear a rod.

The rig may comprise a piercing member (e.g. a needle) operable to provide a hole in the composite structure into which a rod can be inserted.

The skilled person will appreciate that except where mutually exclusive, a feature described in relation to any one of the above aspects of the invention may be applied mutatis mutandis to any other aspect of the invention.

### DESCRIPTION OF THE DRAWINGS

Embodiments of the invention will now be described by way of example only, with reference to the Figures, in which:

FIG. 1 is a sectional side view of a gas turbine engine;

FIG. 2 is a schematic cross section through a laminated composite component reinforced with pins;

FIG. 3 is a schematic cross section of a needle of a rig forming a hole in a composite structure;

FIG. 4 is a schematic cross section of a rig positioning a rod in a hole of a composite structure;

FIG. 5A is a schematic cross section of a rig pushing a rod into a hole and FIG. 5B is a schematic cross section of the pushed rod and pushing foot;

FIG. 6 is a schematic cross section of a rig positioning a plurality of rods in to a composite structure;

FIG. 7 is a plan view of a cropping plate of the rig of FIG. 6; and

FIG. 8 is a schematic cross section of a rig simultaneously pushing a plurality of rods into a composite structure.

### DETAILED DESCRIPTION

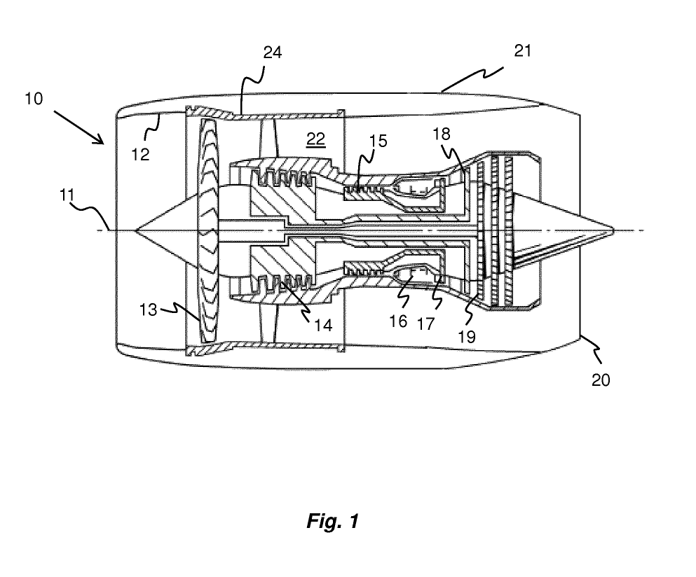

With reference to FIG. 1, a gas turbine engine is generally indicated at 10, having a principal and rotational axis 11. The engine 10 comprises, in axial flow series, an air intake 12, a propulsive fan 13, an intermediate pressure compressor 14, a high-pressure compressor 15, combustion equipment 16, a high-pressure turbine 17, and intermediate pressure turbine 18, a low-pressure turbine 19 and an exhaust nozzle 20. A nacelle 21 generally surrounds the engine 10 and defines both the intake 12 and the exhaust nozzle 20.

The gas turbine engine 10 works in the conventional manner so that air entering the intake 12 is accelerated by the fan 13 to produce two air flows: a first air flow into the intermediate pressure compressor 14 and a second air flow which passes through a bypass duct 22 to provide propulsive thrust. The intermediate pressure compressor 14 compresses the air flow directed into it before delivering that air to the high pressure compressor 15 where further compression takes place.

The compressed air exhausted from the high-pressure compressor 15 is directed into the combustion equipment 16 where it is mixed with fuel and the mixture combusted. The resultant hot combustion products then expand through, and thereby drive the high, intermediate and low-pressure turbines 17, 18, 19 before being exhausted through the nozzle 20 to provide additional propulsive thrust. The high 17, intermediate 18 and low 19 pressure turbines drive respectively the high pressure compressor 15, intermediate pressure compressor 14 and fan 13, each by suitable interconnecting shaft.

The fan blades of the fan 14 and/or the casing 24 surrounding the fan may be made from a composite material, for example, plies of a fibre reinforced resin matrix. To improve structural integrity and resist delamination the fan blades and/or casing may need to be reinforced in a direction tangential to plies of a laminated structure defining the fan blades or casing. One method of reinforcing a composite component is to pin the component.

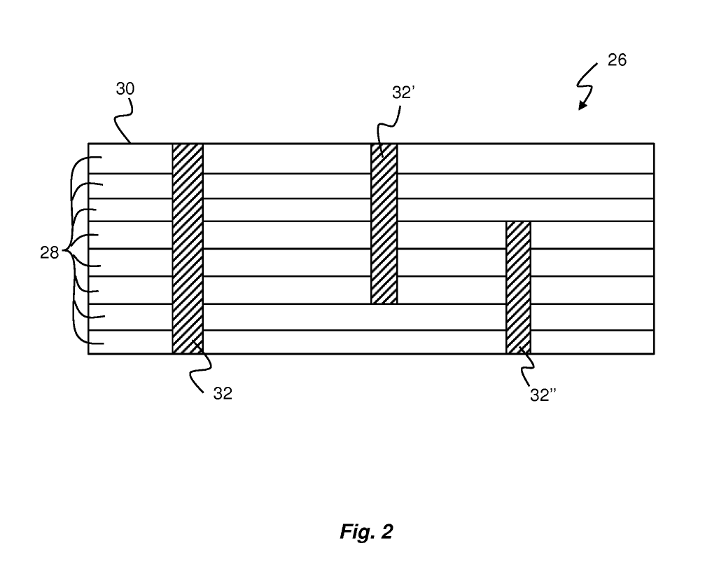

A composite component is indicated generally at 26 in FIG. 2. The composite component 26 includes a plurality of plies 28 stacked to define a laminated structure 30. The composite component is reinforced by pins 32, 32′ and 32″. The pins extend through the composite component in a direction perpendicular to the direction of the plies. As illustrated in FIG. 2, a pin 32 can extend through the entire thickness of the component, or a pin 32′, 32″ can extend through part of the thickness of the component and the pins may be arranged on the same side or on opposite sides of the component.

A method of forming a component similar to the component 26 will now be described in more detail.

Firstly a laminated structure is formed by laying plies on top of each other. The method of forming a laminated structure is well understood in the art, so will not be described in detail here, but may include laying the plies by hand or forming a ply using tape that may be laid using an automated fibre placement machine.

In the present example, the composite structure is heated to a pre-determined temperature for a pre-determined length of time. The pre-determined temperature and length of time is dependent upon the matrix material of the composite structure, and is selected such that the gel point of the matrix material is not reached so as to avoid curing the composite structure. The gel point can be defined as the start of the cure reaction for the matrix material, i.e. the point at which the molecules of the matrix material begin linking together (or gelling) and the material starts to harden.

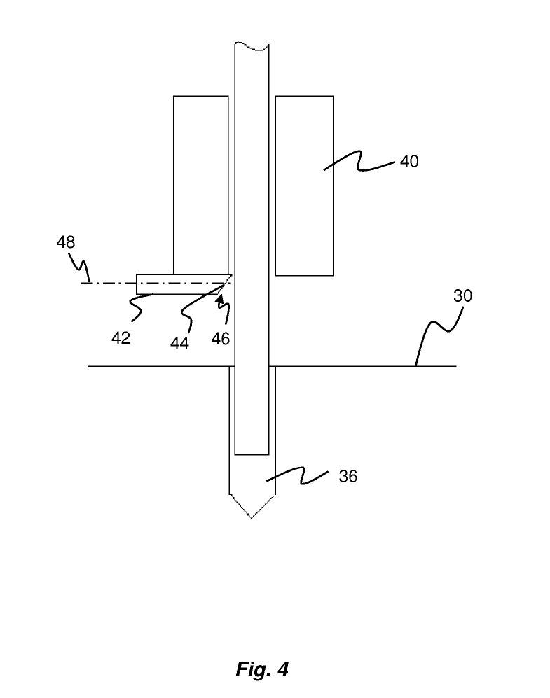

The temperature the composite structure is heated to is selected so as to soften the material of the composite structure. Once the material is softened one or more holes are formed in the composite structure. Referring to FIG. 4, the rod insertion device is provided with a needle 34. A hole 36 is formed in the composite structure 30 using the needle 34. The needle 34 includes a conical end to ease initial formation of the hole. The needle 34 may be rotated during formation of the hole. The method of heating the composite structure and forming a hole in said composite structure is explained in detail in U.S. Pat. No. 8,893,367 incorporated herein by reference, for example the method is described in detail in paragraphs [0050] to [0064] of EP2581201A1 (corresponding to U.S. Pat. No. 8,893,367).

Referring now to FIG. 4, once a hole 36 has been formed in the laminated structure 30, a reinforcement rod 38 is positioned the hole. The reinforcement rod may be made from any suitable material, but in the present example the rod is a fibrous carbon reinforcement rod. The rod is dimensioned such that the rod protrudes from the hole 36 when positioned therein.

The rod 38 is guided into the hole 36 using the guide 40. In the present example, the guide 40 is a tube. The inner diameter of the tube is dimensioned to be a close fit to the rod. That is, the tube is dimensioned so that the rod can slide relative to the guide, but is still supported by the guide.

A feeder mechanism may be provided to feed the rod through the guide, or alternatively the rod may be fed by hand.

Once the rod 38 is positioned in the hole 36 the rod is cropped to a desired length. In the present example the rod is cropped by shearing the rod. Shearing the rod is a particularly suitable cropping mechanism when the rod is made from carbon.

A plate 42 is provided adjacent the guide 40 and defines a cropper for cropping the rod. The plate 42 is configured to slide relative to the guide 40. In the present example, the plate 42 slides substantially parallel to a surface of the laminated structure 30 in which the hole is formed. The plate 40 includes a surface 44 that is angled so as to form a tapered portion 46 of the plate. The surface 44 may be angled at any suitable angle, but for example may be angled at an angle equal to or between 30 and 60°, e.g. 45°, to a principle plane (indicated by line 48) of the plate 42.

To crop the rod 38, the plate 42 slides towards the rod and impacts the rod. The tapered portion 46 of the plate 42 increases the likelihood of a “clean shear” of the rod 38.

As will be appreciated by the person skilled in the art, it is important to avoid splaying of the end of the rod 38 when it is cropped, and the tapered portion 46 of the plate contributes to achieving this. It is also important to avoid bending and potential double fracture of the rod. To mitigate the risk of bending of the rod, the plate 42 is provided adjacent the guide 40 so as to be as close to the support of the guide as possible whilst being able to slide relative thereto. The distance of the plate to the surface of the laminated structure 30 is shown exaggerated in FIG. 4, and will be closer to the surface of the laminated structure. The distance of the surface of the laminated structure to the plate 42 is selected so as ensure that the plate 42 is spaced from the surface of the laminated structure to eliminate the risk of the plate contacting the surface of the laminated structure, but the plate 42 to close enough to the surface of the laminated structure to reduce the risk of the rod 38 bending and potentially fracturing at the surface of the laminate structure in addition to the point of impact of the cropper. In addition, the distance the cropper is allowed to slide past the rod is limited. When the plate 42 impacts the rod 38, bending of the rod 38 is avoided because the unsupported length of the rod is small and the cropper does not travel further than required to shear the rod; one end of the rod is supported by the hole 36 and the opposite end of the rod is supported by the guide 40.

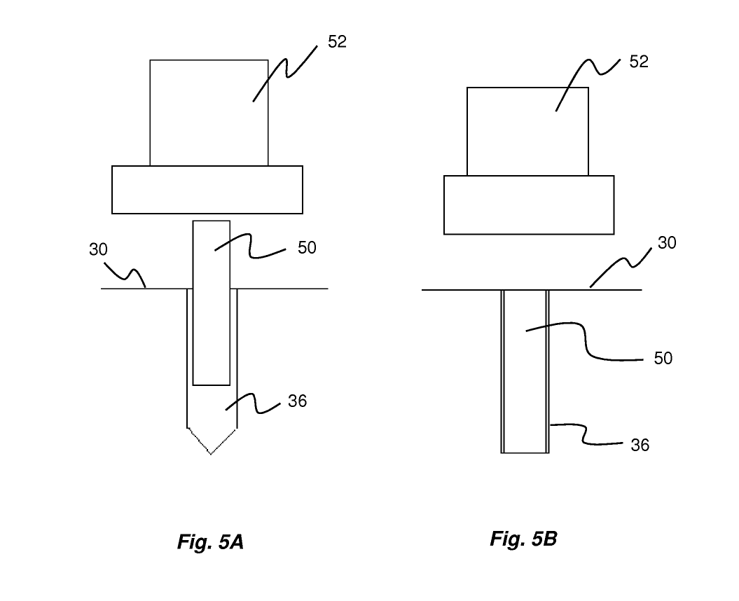

Referring now to FIGS. 5A and 5B, once the rod 38 is cropped so as to form a cropped rod 50 (which may also be referred to as a pin), the cropped rod is pushed into the hole 36 so as to be flush with the surface of the laminated structure 30. The cropped rod 50 is pushed into the hole using a pushing foot 52. The pushing foot may take any form arranged to contact an end surface of the cropped rod 50 and supply sufficient force so as to push (or press) the cropped rod into the hole.

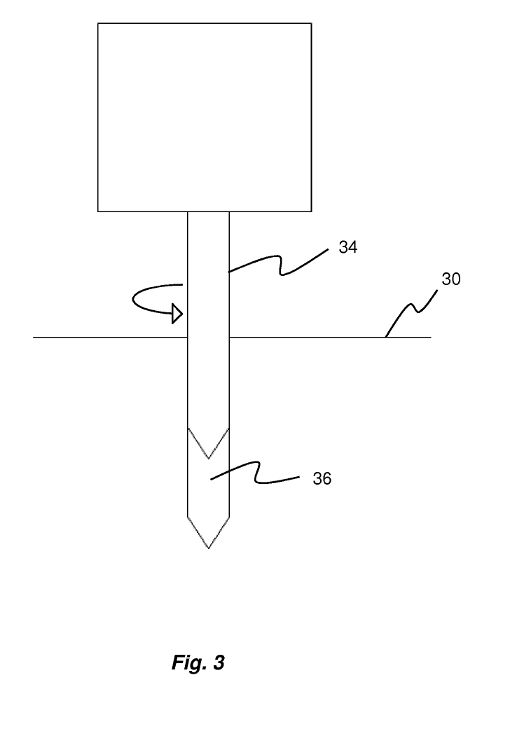

A rig may be provided to perform one or more of the above mentioned method steps. Indeed, FIGS. 3 to 5 illustrate component parts of such a rig.

The above described method of manufacture includes amongst others the following advantages: reducing the risk of bending or splaying of the pin, mitigating the risk of damage to the surface of the laminated structure, producing a final product where the pin is flush to the surface of the laminated structure, and providing a method that can be adapted for mass production.

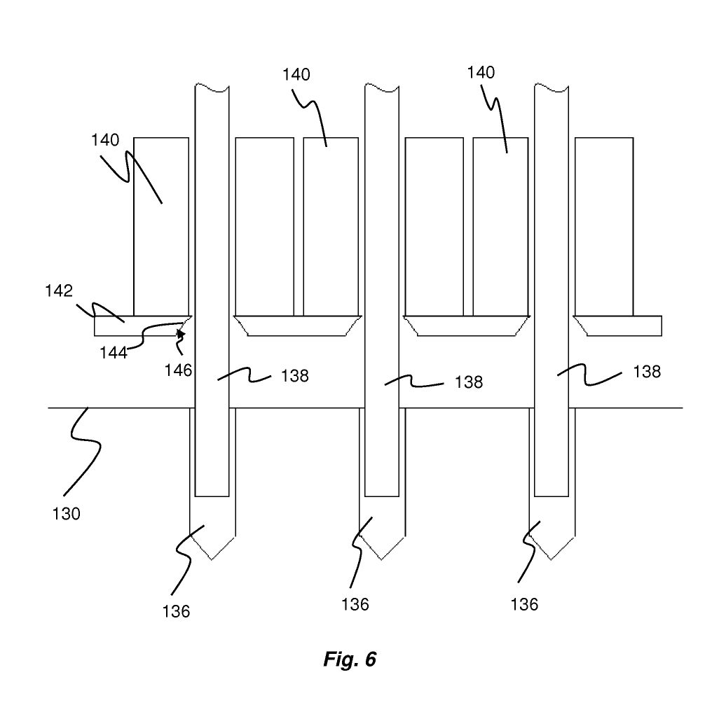

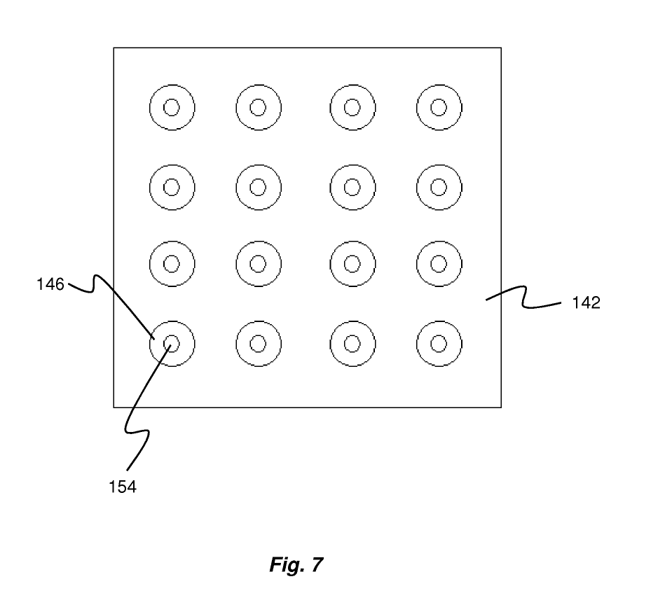

The described method may be scaled to insert, crop, and push a plurality of rods at the same time. Referring to FIGS. 6 to 8 an example of such an arrangement will now be described. Similar features are given similar reference numerals but with a prefix “1” to distinguish between examples. Referring to FIG. 6, a plurality of guides 140 is provided. Each guide 140 is a tube and is similar to the previously described guide. Each guide guides one rod 138 into one hole 136.

A plurality of croppers is provided so that each of the rods 138 can be cropped to length at the same time. In the present example, the croppers are defined by a plate 142 provided with a plurality of countersunk holes 154 (only one labelled). One rod 138 is fed from the guide 140 through one of the holes 154 in the plate 142 and then into one of the holes 136 of the laminated structure 130. The countersink of the holes 154 defines an angled surface 144 of a tapered portion 146 of the plate, similar to the tapered portion described in the previous example. To crop the rods, the plate 142 is moved towards the rods and the surface of each countersunk hole impacts the rod received therein so as to initiate shear of the rod.

The provision of the plate 142 defining a plurality of croppers means that the time required to crop a plurality of rods is reduced, and the life of the croppers can be increased compared to using a single cropper to cut every rod. Further, the arrangement of the plate 142 means that the travel of the plate is reduced so there is reduced risk of the plate 142 causing damage to a cropped rod. For example, there is a possibility of damage to a cropped rod occurring if the plate moves across it so as to crop an adjacent rod.

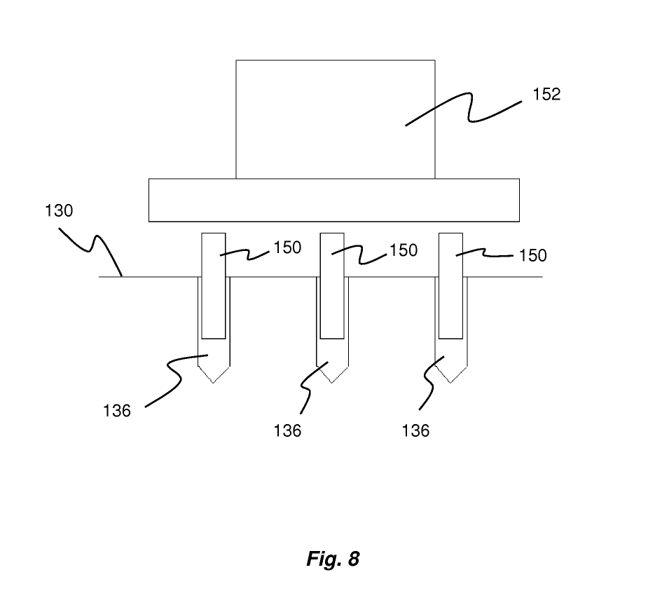

Once the rods 138 are cropped, a plurality of pusher feet may be provided. Alternatively, as shown in FIG. 8, a single pusher foot 152 may be provided to push the plurality of cropped rods 150 into the plurality of holes 136 at the same time.

It will be understood that the invention is not limited to the embodiments above-described and various modifications and improvements can be made without departing from the concepts described herein. Except where mutually exclusive, any of the features may be employed separately or in combination with any other features and the disclosure extends to and includes all combinations and sub-combinations of one or more features described herein.

For example, the composite component has been described with reference to a fan blade and/or a fan case of a gas turbine engine, but it will be understood that the method described herein is applicable to any composite component that is reinforced using reinforcing rods (e.g. pins).

In the described examples, the rods have been inserted from the same side of the laminated structure, but as will be appreciated rods can be inserted into the opposite side of the laminated structure using the same method but presenting the opposite surface of the laminated structure to the rig. The rods in the described examples extend part way through the laminated structure, but the rods may be arranged to extend across the full thickness of the laminated structure.

The guide has been described as a tube, but the guide may take any suitable form, for example the guide may include a plurality of jaws, or a jet of water or air. The guide may actively feed the rod into the holes of the laminated structure or the rod may be fed by a separate feeding mechanism.

In the described example having a plurality of croppers, a single plate defined each of the plurality of croppers but in alternative embodiments a plurality of plates may be provided, each defining one or more of the croppers.

In the described examples the cropper has cropped the rod to length using shear, but in alternative examples the rod may be cropped to length using alternative methods (e.g. sawing for example).

The described example refers to a composite structure that is laminated, but the method may be used to reinforce alternative composite structures. For example, bolt holes provided in 3D woven structures.

1. A method of reinforcing a fibre reinforced resin matrix composite structure, the method comprising:
providing a composite structure with one or more holes provided therein;
positioning a reinforcement rod in a hole of the composite structure, the reinforcement rod being dimensioned to protrude from the hole;
cropping the reinforcement rod to a desired length; and
pushing the cropped reinforcement rod into the composite structure by a desired amount.

2. The method according to claim 1, wherein the rod is cropped at a position spaced from a surface of the composite structure.

3. The method according to claim 1, further comprising providing a guide that guides the reinforcement rod into the hole, and wherein the reinforcement rod is cropped at a position adjacent the guide.

4. The method according to claim 2, wherein the guide is a tube dimensioned to support the rod and permit the rod to slide relative to the guide.

5. The method according to claim 1, wherein the reinforcement rod is cropped to the desired length by shearing the rod.

6. The method according to claim 5, wherein the reinforcement rod is sheared using a plate having a tapered portion that impacts the rod to initiate shear.

7. The method according to claim 1, wherein the method includes providing a composite structure having a plurality of holes and positioning a rod in each of the holes, and further comprising cropping each of the rods.

8. The method according to claim 7, wherein a plurality of croppers are provided and each rod is cropped by a different cropper.

9. The method according to claim 8, wherein a plate defines the plurality of croppers, and wherein the plate is provided with a plurality of countersunk holes operable to crop a rod.

10. The method according to claim 1, further comprising heating the composite structure to a predetermined temperature and forming one or more holes in the heated composite structure.

11. A method of reinforcing a fibre reinforced resin matrix composite structure, the method comprising:
providing a composite structure with a hole provided therein;
positioning a reinforcement rod in the hole, wherein the reinforcement rod is dimensioned to protrude from the hole; and
cropping the reinforcement rod to a desired length after the rod has been positioned in the hole.

12. The method according to claim 11, wherein the reinforcement rod is cropped by shearing the reinforcement rod.

13. A method of manufacturing a composite component comprising laying a plurality of plies to form a laminated structure and reinforcing the laminated structure using the method according to claim 1.

14. The method according to claim 13, wherein the composite component is a fan blade for a gas turbine engine.

15. A rig for positioning a reinforcing rod in a fibre reinforced resin matrix composite structure; the rig comprising:
a cropper for cropping a rod to a desired length at a distance spaced from the surface of the composite structure; and
a pusher foot for pushing a rod into a hole in the composite structure.

16. The rig according to claim 15 further comprising a guide for guiding a rod into a hole provided in the composite structure.

17. The rig according to claim 16, wherein the cropper is configured to slide relative to the guide and adjacent to said guide.

18. The rig according to claim 16, wherein cropper includes a plate having a tapered portion arranged to impact a rod.

19. The rig according to claim 17, comprising a plurality of guides for guiding a plurality of rods into a plurality of holes in a composite structure.

20. The rig according to claim 19, comprising a plurality of croppers, each cropper being arranged to crop a different rod.

21. The rig according to claim 20, wherein the cropper includes a plate having a plurality of holes for receiving a plurality of rods, and wherein each hole is countersunk to provide a tapered portion operable to shear a rod.
